(19) United States
(12) Patent Application Publication
(10) Pub. No.: US 2026/0326526 A1
(43) Pub. Date: Oct. 22, 2026

(54) ELECTRIC POWERTRAIN FOR A COMMERCIAL VEHICLE WITH TWO ELECTRIC MOTORS

(71) Applicants: Abdullah JABER, Aachen (DE); Raid MAZYEK, Stolberg (DE); Helko MUES, Aachen (DE); TRAILER DYNAMICS GMBH, Eschweiler (DE)

(72) Inventors: Abdullah JABER, Aachen (DE); Raid MAZYEK, Stolberg (DE); Helko MUES, Aachen (DE)

(73) Assignee: TRAILER DYNAMICS GMBH, Eschweiler (DE)

(21) Appl. No.: 19/109,821

(22) PCT Filed: Sep. 7, 2023
(86) PCT No.: PCT/EP2023/074622

§ 371 Date: Mar. 7, 2025

(30) Foreign Application Priority Data
Sep. 9, 2022 (DE) 10 2022 123 036.8

(51) Int. Cl. B60K 1/02; B60K 17/08

(52) U.S. Cl. CPC B60K 1/02; B60K 17/08

(57) ABSTRACT

An electric powertrain (20) for a commercial vehicle (2) with two electric motors (22), on which commercial vehicle the occurring torques can be better managed, arranges the electric motors (22) in motor housings (24) located on opposite sides of a transmission housing (26) located between the motor housings (24). Each electric motor (22) acts on a motor-side output shaft (28) that extends out of the motor housing (24) of the electric motor (22) assigned to this output shaft (28) through to and into the transmission housing (26). In the transmission housing (26), at least one gear stage (30) is provided for each motor-side output shaft (28), via which gear stage the respective drive force introduced into the transmission housing (26) with the motor-side output shaft (28) is transferred to a respective transmission-side output shaft (32).

The present invention relates to an electric powertrain for a commercial vehicle with two electric motors according to the preamble of claim 1 and to a commercial vehicle with an electric powertrain with two electric motors.

Document WO 98/40958 A1 discloses an electric drive unit for a motor vehicle with two electric drives arranged in a common housing and aligned with one another on axes of rotation. Each electric motor drives its own rotor shaft. The output-side ends of the rotor shafts are led out of the drive housing on opposite sides. The ends of the rotor shafts facing each other are mounted in a bearing shield arranged centrally in the housing.

This design results in a drive housing that is long and has to withstand considerable drive torques over its length. Considerable forces are generated between the distal ends of the rotor shafts in particular and are absorbed by the drive housing and transferred to the vehicle frame of the commercial vehicle in which the powertrain is mounted. Vibrations that occur in the electric motors are not only transferred to the downstream drive components via the output-side ends of the rotor shafts, but also to the drive housing via the housing fit.

The object of the present invention is to create an electric powertrain for a commercial vehicle with two electric motors in which the torques that occur can be better controlled. In addition, a solution is to be found in which the vibrations from the electric motors are transferred to the downstream drive components to a lesser extent. The unsprung masses should also be kept low. An offset is also to be created between the drive shaft and the output shaft in order to enable a compact design of the drive unit.

The object is achieved for an electric powertrain by the characterizing features of claim 1 and for a commercial vehicle by the characterizing features of claim 10.

The electric motors are arranged in motor housings that are located on opposite sides of a transmission housing located between the motor housings. The transmission housing arranged between the two motor housings can easily absorb and compensate for forces occurring between the motor housings and the resulting vibrations acting on the transmission housing. The side walls of the transmission housing facing the electric motors can be dimensioned with sufficient strength to attach the motor housings to them. As each motor housing is assigned a side wall of the transmission housing, the vibrations and drive torques for each electric motor initially only act on the side wall of the transmission housing facing the electric motor. The side walls of the transmission housing can be designed as solid plates made of a metallic material. The side walls of the transmission housing facing the electric motors can be connected to each other by a peripheral side wall of the transmission housing. The side walls facing the electric motors can also be used to support the gears that form the gear stages in the transmission housing. This also applies to the transmission-side output shafts and to the cardan shafts arranged outside the transmission housing, which transmit the drive forces acting on the transmission-side output shafts to the driven wheels of the commercial vehicle.

Each electric motor acts on a motor-side output shaft that extends out of the motor housing of the electric motor assigned to this output shaft through to and into the transmission housing. A separate output shaft is provided for each electric motor so that they can be operated independently of each other at different speeds and drive torques. In such an arrangement, any drive torques and vibrations that occur do not act directly on the other electric drive motor, but are at best transferred indirectly from a first output shaft to the second output shaft via the transmission housing. The rotor of the associated electric motor can be mounted directly on the respective motor-side end of an output shaft. In this way, the drive force generated by the electric motors can be introduced directly into the transmission housing without further transmission losses.

In the transmission housing at least one gear stage is provided for each motor-side output shaft, via which gear stage the respective drive force introduced into the transmission housing with the motor-side output shaft is transferred to a respective transmission-side output shaft. Each motor-side output shaft is therefore assigned its own transmission-side output shaft. The transmission-side output shafts are preferably arranged in the transmission housing in such a way that their axis of rotation is parallel to the axes of rotation of the motor-side output shafts, but not concentric with them, so that there is an offset between these output shafts. The offset should preferably be so large that the cardan shafts, which transmit the drive forces acting on the transmission-side output shafts to the driven wheels of the commercial vehicle, can be connected to the transmission housing outside the peripheral shape of the motor housing. The gear stages serve the purpose of bridging the offset between the output shafts.

The drive forces applied to the transmission-side output shafts are transferred via cardan shafts, each of which is drive-connected to one of the transmission-side output shafts and arranged on opposite sides of the transmission housing, to wheels of the commercial vehicle which are drive-connected to the respective cardan shafts. The cardan shafts are suitable for following the compression and rebound movements of the wheels when the commercial vehicle is in use. If the transmission housing and the motor housing are rigidly connected to the vehicle frame of the commercial vehicle, the cardan shafts are the only parts of the powertrain of which the mass is unsprung. As the cardan shafts are comparatively light, this has advantages for the driving behavior and the smooth running of the commercial vehicle during use. In particular, the heavy electric motors and the transmission are not part of the unsprung masses.

In the powertrain for a commercial vehicle according to the invention, each of the two electric motors therefore has its own transmission path for transmitting the drive force to the wheels it drives. The vibrations occurring during operation of the electric motors can be kept to a minimum. The torques occurring in the powertrain designed according to the invention can be easily controlled.

The commercial vehicle can be a truck trailer in particular. With truck trailers, it is particularly difficult to accommodate an electric powertrain in the available installation space below the loading area. The available installation space width is limited by legal approval regulations. In addition, axle swing arms, suspension elements, shock absorbers and brakes must be arranged in the area of the wheels. The design of the electric powertrain according to the invention makes optimum use of the available installation space.

According to one embodiment of the invention, the powertrain has an electronic speed control of the electric motors, which is designed to compensate for speed differences between the wheels driven by the powertrain. The electronic speed control of the electric motors creates an electronic differential. If speed differences occur between opposite wheels of a commercial vehicle, which can be the case in particular when the commercial vehicle is cornering, it is possible to neutralize the speed differences via the decoupled transmission paths by controlling the speed of the electric motors accordingly. For speed equalization, the speed of the electric motor that drives a wheel on the outside of the bend can be increased via the electronic speed control, while the speed of the electric motor that drives a wheel on the inside of the bend is reduced via the electronic speed control. It is also possible to change the speed of only one of the two electric motors in a suitable direction for speed compensation via the electronic speed control. The speed of the electric motors can be changed via an appropriately programmed electronic control system, which detects speed differences between driven wheels via suitable sensors and adjusts the speeds of the electric motors to a level required for speed compensation. A mechanical differential can then be dispensed with in the powertrain according to the invention, which further reduces the overall mass of the powertrain and the unsprung masses. Reactive power in the powertrain is avoided. The electronic speed control is controlled in such a way that it neutralizes differences in the travel of a wheel on the inside and outside of a bend as far as possible. The separate drive paths of the electric motors to the wheels driven by them enable individual control of the individual driven wheels.

According to one embodiment of the invention, the powertrain has an electronic power control of the electric motors, which is designed to generate a retarding or accelerating drive torque by changing the drive torque generated by one or both electric motors at the wheel driven by the respective electric motor affected by the power control. The electronic torque control aims to influence the yaw angle speed of the commercial vehicle around its vertical axis in certain driving situations. This is a torque vectoring control system that is designed to improve the driving characteristics of the commercial vehicle. For example, the cornering behavior of the commercial vehicle can be improved if the wheel on the inside of the bend is slightly decelerated with a retarding torque, causing the commercial vehicle to turn into the bend. A comparable effect, which is brought about as a substitute for or in support of the change in torque of the wheel on the inside of the bend, can be achieved if the wheel on the outside of the bend pushes forwards with an accelerating drive torque.

The retarding and/or accelerating drive torque can also be used to stabilize the handling of the commercial vehicle when driving straight ahead. This applies, for example, if the commercial vehicle tends to sway or oscillate in a driving situation due to driving errors, uneven road surfaces or weather conditions. Drive torques are then specifically generated at the wheels to counteract any swaying or oscillation. The retarding and/or accelerating drive torques can be achieved by controlling the electric motors electronically. The separate drive paths from the electric motors to the respective wheels driven by them make it possible to control the individual driven wheels individually. Driving conditions in which the torque control described above is useful can be detected using a suitable sensor system. Yaw rate sensors, for example, can be used to detect rotational movements of the commercial vehicle around its vertical axis. The sensor data of the yaw rate sensor can be offset by an electronic control unit with other sensor data, for example from wheel speed sensors, in order to calculate a signal from this as to whether and to what extent a corresponding drive torque is required and/or helpful to support the driving behavior of the commercial vehicle.

According to one embodiment of the invention, the gear stages have a transmission ratio by which the speeds of the transmission-side output shafts are unequal to the speeds of the motor-side output shafts of the electric motors. Depending on the design of the electric motors, it is possible that their speeds in normal operation are at a level at which the wheels of the commercial vehicle rotate at speeds that do not correspond to the speeds at which the commercial vehicle travels in normal operation when the transmission ratio of the gear stages in the transmission housing is 1:1. By correspondingly increasing or decreasing the speeds of the motor-side output shafts to changed speeds of the transmission-side output shafts by means of the transmission ratio of the gear stages, the electric motors can be operated at speeds which, with a transmission ratio of 1:1, do not match the speeds of the wheels to be expected during normal operation of the commercial vehicle. The speeds of the electric motors that are made possible by the reduction or reduction ratio can be advantageous in terms of wear and/or energy consumption. If there is at least one automatically or manually shiftable gear stage in the transmission housing, the transmission-side output shafts can be driven at different speeds with the same input speed of the motor-side output shafts.

According to one embodiment of the invention, the transmission housing and/or the motor housings have one or more connecting elements with which the electric powertrain can be attached to a vehicle frame of the commercial vehicle. Using the connecting elements, it is possible to connect the heavy components of the powertrain to a vehicle frame of the commercial vehicle. Advantageously, fastening brackets can be arranged on the motor housings, via which the motor housings can be connected to the vehicle frame of a commercial vehicle. In particular, the mounting brackets can be arranged at the outward-facing ends of the motor housings in order to support the weights of the electric motors there. In addition, the transmission housing can be provided with at least one connecting element in order to also support the weight of the transmission housing together with the shafts and gear stages arranged therein. Alternatively, the transmission can accommodate at least two connecting elements and thus enable the electric motors to be attached to the transmission on one side, thereby relieving the load on the housing of the electric motors. The connecting elements can be designed to use known joining techniques, such as welding, screwing, riveting, gluing and the like, to connect the powertrain to the vehicle frame of a commercial vehicle. The heavy components of the powertrain are thus fixed to the vehicle frame of the commercial vehicle. This keeps the unsprung masses low.

According to one embodiment of the invention, the electric powertrain has a torque bracket as a connecting element, one end of which is attached to the transmission housing. Preferably, the torque bracket engages the transmission housing in an area remote from the motor-side output shafts, as this is where the differential torque between the input and output is greatest. The transmission housing is particularly suitable for attaching the torque bracket because it must be designed to be particularly rigid in order to hold the electric motors attached to it and prevent torsional movements of the transmission housing. The torque bracket transfers the differential torque to the vehicle frame of the commercial vehicle. Furthermore, the forces are transferred centrally into the frame structure by the torques from the torque bracket, which prevents torsion of the vehicle frame. A torque bracket relieves the strain on other connecting elements for connecting the powertrain to the vehicle frame of a commercial vehicle. Other connecting elements can thus be made lighter and simpler.

According to one embodiment of the invention, the connecting element or elements have silent blocks. The silent blocks are suitable for at least reducing or completely avoiding the transmission of vibrations and oscillations from the powertrain to the vehicle frame of a commercial vehicle. Silent blocks are components in which metal connecting elements are connected to each other by components made of an elastomeric material in order to damp pressure, shear and/or tensile loads and vibrations between the connected components. Due to their design, the silent blocks not only prevent the transmission of vibrations from the electric motors to the vehicle frame of the commercial vehicle, they also damp shocks and impacts as well as influences from torsional movements of the vehicle frame, which act on the powertrain from the vehicle frame. Alternating torques from the drive can also be at least partially absorbed by the silent blocks. In addition, the silent blocks allow the vehicle frame to twist without transferring the resulting forces equally to the drive structure.

According to one embodiment of the invention, in a side view, the transmission housing projects beyond the peripheral shapes of the motor housings in one direction and the transmission-side output shafts and the connections of the cardan shafts to the transmission housing are arranged in the part of the transmission housing projecting beyond the peripheral shapes of the motor housings. This design keeps the installation space required by the powertrain to a minimum. Due to the design, the cardan shafts are not attached to the outer ends of the electric motors, but to the part of the transmission housing that protrudes beyond the motor housings, thus increasing the distance over which the cardan shafts extend. From the driven wheels, the cardan shafts extend further into the central area of the commercial vehicle. The greater length of the cardan shafts in a direction transverse to the longitudinal axis of the commercial vehicle reduces the angular degrees that must be compensated for via the universal joints of the cardan shafts during their operation in order to bridge the distance between the motor-side output shafts and the axes of rotation of the driven wheels when viewed in the longitudinal direction of the commercial vehicle and/or in the vertical direction. In addition, the offset enables the cardan shafts to be deflected due to the ride heights that must necessarily be set on a commercial vehicle. This reduces wear on the universal joints of the cardan shafts. In practical operation, the cardan shafts thus achieve a significantly longer service life.

According to one embodiment of the invention, the connections of the cardan shafts on the transmission housing are offset from the axes of rotation of the motor-side output shafts in the direction of the axes of rotation of the wheels driven by the powertrain. The connections of the cardan shafts are located in particular in the part of the transmission housing in which the transmission housing protrudes beyond the peripheral shapes of the motor housings in a side view. Viewed in the longitudinal direction of the commercial vehicle and/or in the vertical direction, the distance between the axis of rotation of the motor-side output shafts and the axes of rotation of the driven wheels is thus shortened. The shortened distance reduces the angular degrees that the universal joints of the cardan shafts have to compensate for during operation. This reduces wear on the universal joints of the cardan shafts. In practical operation, the cardan shafts therefore achieve a significantly longer service life.

It should be noted that the aforementioned embodiments of the invention, in each by themselves, but also with each other, can be combined with the subject matter of claim 1 and the other dependent claims, provided that no technical obstacles stand in the way and there are no mandatory dependencies.

Further modifications and embodiments of the invention can be found in the claims, the description and the drawings.

The invention is explained in greater detail below on the basis of an exemplary embodiment, in which:

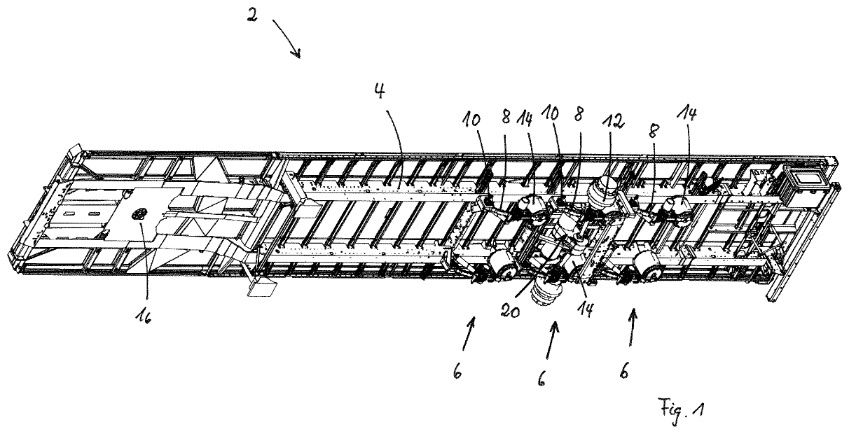

FIG. 1: shows an overall view of an electric powertrain installed in a commercial vehicle from diagonally below,

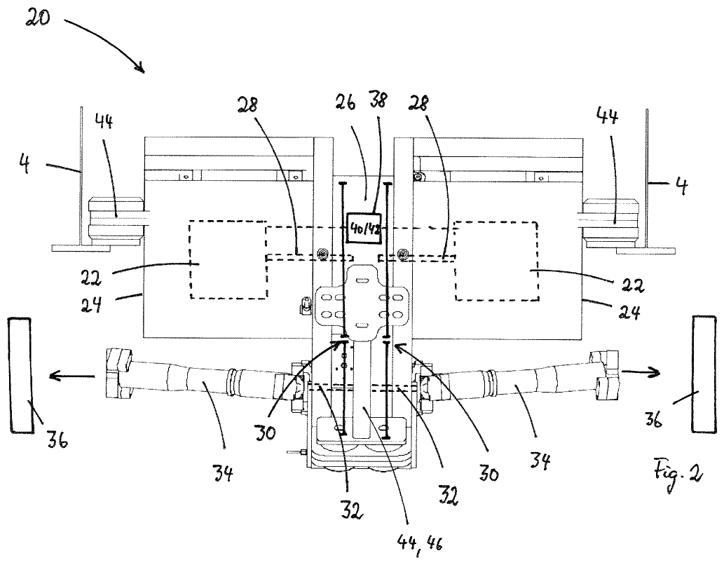

FIG. 2: shows a front view of the electric powertrain mounted in a vehicle frame with the electric motor/transmission assembly, and

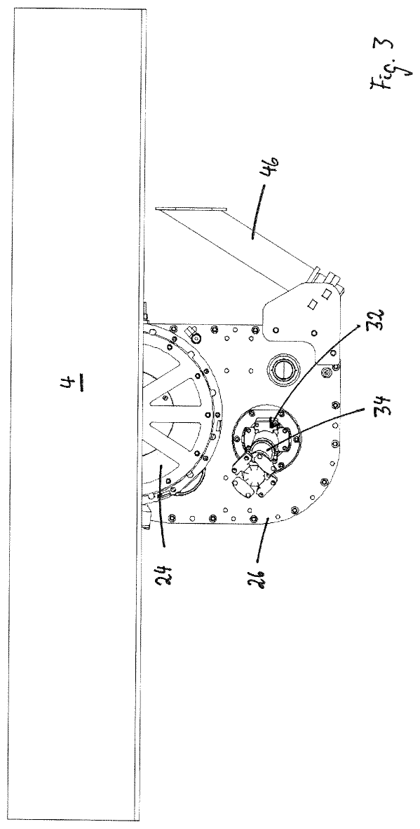

FIG. 3: shows a side view of the electric motor/transmission assembly mounted in a vehicle frame.

FIG. 1 shows an overall view of a commercial vehicle 2 in the form of a truck trailer from diagonally below, in which an electric powertrain 20 is installed. The commercial vehicle 2 has a vehicle frame 4, which is supported on the ground by three axle structures 6 in the exemplary embodiment. The middle axle structure 6 has the electric powertrain 20, while the axle bridge or axle is omitted from the two other axle structures for reasons of simplification. In the front area, the commercial vehicle with the kingpin 16 is placed on the fifth wheel coupling of a semitrailer truck, which is not shown in detail in the drawing, and pulled over it.

The axle structures 6 each have a link arm 8 on opposite sides of the vehicle frame 4, which is connected to the vehicle frame 4 via a pivot bearing 10 arranged in a retaining bracket. A wheel carrier 12, to which the wheels of the commercial vehicle 2 can then be bolted, is also attached to the link arm 8. At their end facing away from the pivot bearing 10, the link arms 8 are each supported on the vehicle frame by a spring element 14. The link arms 8 therefore rotate around the pivot bearing 10 during spring movements and spring against the restoring forces in the flexible spring elements 14.

FIG. 2 shows a view from the front of an electric powertrain 20 mounted in a vehicle frame 4 with the associated electric motor/transmission assembly. The electric powertrain 20 has two electric motors 22, indicated by dashed lines, each of which is arranged in an associated motor housing 24. The two motor housings 24 are mounted on opposite sides of a transmission housing 26. Each electric motor 22 has a motor-side output shaft 28, which extends from the motor housing 24 of the electric motor 22 associated with this output shaft 28 into the transmission housing 26. In the transmission housing 26 at least one gear stage 30 is provided for each motor-side output shaft 28, via which gear stage the respective drive force introduced into the transmission housing 26 with a motor-side output shaft 28 is transferred to a respective transmission-side output shaft 32. The gear stages 30 can have a transmission ratio by which the rotational speeds of the transmission-side output shafts 32 are unequal to the rotational speeds of the motor-side output shafts 28 of the electric motors 22. The driving forces applied to the transmission-side output shafts 32 are transferred via cardan shafts 34, which are each drive-connected to one of the transmission-side output shafts 32 and arranged on opposite sides of the transmission housing 26, to wheels 36 of the commercial vehicle 2 which are drive-connected to the cardan shafts 34.

An electronics box 38 is shown in FIG. 2, which is connected to the electric motors 22 via lines shown in dashed lines. The electronic speed control 40 and the electronic power control 42 are arranged in the electronics box 38. For these functions, the electronics box 38 can also be connected to other sensors, not shown in detail in the diagram, which are arranged in the electronic vehicle train 20 and/or on the commercial vehicle 2.

In the exemplary embodiment, the transmission housing 26 and/or the motor housing 24 are connected to the vehicle frame 4 of the commercial vehicle 2 via connecting elements 44. One of the connecting elements 44 is designed as a torque bracket 46, which is attached at one end to the transmission housing 26 and at its other end to the vehicle frame 4 of the commercial vehicle 2. The connecting elements 44 are connected to the vehicle frame 4 via silent blocks 48.

In the side view shown in FIG. 3, the transmission housing 26 projects downwards in one direction beyond the peripheral shapes of the motor housings 24. The transmission-side output shafts 32 and the connections of the cardan shafts 34 are arranged on the transmission housing 26 in the part of the transmission housing 26 projecting beyond the peripheral shapes of the motor housings 24. The connections of the cardan shafts 34 on the transmission housing 26 are also offset from the axes of rotation of the motor-side output shafts 28 in the direction of the axes of rotation of the wheels 36 driven by the powertrain 20.

The invention is not limited to the exemplary embodiment described above. A person skilled in the art will have no difficulty in modifying the exemplary embodiment in a way that seems suitable to them in order to adapt it to a specific application.

### LIST OF REFERENCE SIGNS

2 commercial vehicle
4 vehicle frame
6 axle structure
8 link arm
10 pivot bearing
12 wheel carrier
14 spring element
20 electric powertrain
22 electric motor
24 motor housing
26 transmission housing
28 motor-side output shaft
30 gear stage
32 transmission-side output shaft
34 cardan shaft
36 wheel
38 electronics box
40 electronic speed control
42 electronic power control
44 connecting element
46 torque bracket
48 silent block

1. An electric powertrain (20) for a commercial vehicle (2) with two electric motors (22), characterized in that the electric motors (22) are arranged in motor housings (24) located on opposite sides of a transmission housing (26) located between the motor housings (24), each electric motor (22) acts on a motor-side output shaft (28) that extends out of the motor housing (24) of the electric motor (22) assigned to this output shaft (28) through to and into the transmission housing (26), in the transmission housing (26) at least one gear stage (30) is provided for each motor-side output shaft (28), via which gear stage the respective drive force introduced into the transmission housing (26) with the motor-side output shaft (28) is transferred to a respective transmission-side output shaft (32), and the drive forces acting on the transmission-side output shafts (32) are transferred via cardan shafts (34), which are each drive-connected to one of the transmission-side output shafts (32) and are arranged on opposite sides of the transmission housing (26), to wheels (36) of the commercial vehicle (2) which are drive-connected to the cardan shafts (34).

2. The electric powertrain (20) as claimed in claim 1, characterized in that the powertrain (20) has an electronic speed control (40) of the electric motors (22), which is designed to compensate for speed differences between the wheels (36) driven by the powertrain (20).

3. The electric powertrain (20) as claimed in claim 1, characterized in that the powertrain (20) has an electronic power control (42) of the electric motors (22), which is designed to generate a retarding or accelerating drive torque by changing the drive torque generated by one or both electric motors (22) at the wheel (36) driven by the respective electric motor (22) affected by the power control.

4. The electric powertrain (20) as claimed in claim 1, characterized in that the gear stages (30) have a transmission ratio by which the speeds of the transmission-side output shafts (32) are unequal to the speeds of the motor-side output shafts (28) of the electric motors (22).

5. The electric powertrain (20) as claimed in claim 1, characterized in that the transmission housing (26) and/or the motor housings (24) have one or more connecting elements (44) with which the electric powertrain (20) can be fastened to a vehicle frame of the commercial vehicle (2).

6. The electric powertrain (20) as claimed in claim 5, characterized in that the electric powertrain (20) has a torque bracket (46) as a connecting element (44), which is fastened at one end to the transmission housing (26).

7. The electric powertrain (20) as claimed in claim 5, characterized in that the connecting element or elements (44) comprise silent blocks (48).

8. The electric powertrain (20) as claimed in claim 1, characterized in that, in a side view, the transmission housing (26) projects beyond the peripheral shapes of the motor housings (24) in one direction and the transmission-side output shafts (32) and the connections of the cardan shafts (34) on the transmission housing (26) are arranged in the part of the transmission housing (26) projecting beyond the peripheral shapes of the motor housings (24).

9. The electric powertrain (20) as claimed in claim 1, characterized in that the connections of the cardan shafts (34) on the transmission housing (26) are offset from the axes of rotation of the motor-side output shafts (28) in the direction of the axes of rotation of the wheels (36) driven by the powertrain (20).

10. A commercial vehicle (2) with an electric powertrain (20) with two electric motors (22), characterized in that the electric powertrain (20) is designed according to the features of claim 1.
